(19) United States
(12) Patent Application Publication
(10) Pub. No.: US 2024/0426238 A1
(43) Pub. Date: Dec. 26, 2024

(54) PRE-COMBUSTION CHAMBER IGNITER, METHANOL ENGINE AND COLD START CONTROL METHOD THEREOF

(71) Applicant: Tianjin University, Tianjin (CN)

(72) Inventors: Lei Zhou, Tianjin (CN); Zongkuan Liu, Tianjin (CN); Haiqiao Wei, Tianjin (CN); Fengnian Liu, Tianjin (CN); Lijia Zhong, Tianjin (CN)

(21) Appl. No.: 18/464,864

(22) Filed: Sep. 11, 2023

(30) Foreign Application Priority Data
Jun. 25, 2023 (CN) 202310745467.8

(51) Int. Cl. F02B 19/10; F02B 19/12

(52) U.S. Cl. CPC F02B 19/1009; F02B 19/1014; F02B 19/12; F02B 2019/004

(57) ABSTRACT

Disclosed is a pre-combustion chamber igniter, a methanol engine and a cold start control method thereof. The pre-combustion chamber igniter includes a housing, nozzles, a fuel injector, a spark plug and heating elements. The heating elements at outer surfaces of the nozzles can heat fuel spray sprayed to an inner wall of a pre-combustion chamber. According to the present disclosure, the pre-combustion chamber is heated using the heating elements during a cold start of the methanol engine, and an excess air coefficient of an interior of the pre-combustion chamber can be controlled between 0.8 and 1.0 to achieve ultra-lean combustion of the engine in a cold start state.

### CROSS-REFERENCE TO RELATED APPLICATIONS

This application claims priority of Chinese Patent Application No. 202310745467.8, filed on Jun. 25, 2023, the entire contents of which are incorporated herein by reference.

### TECHNICAL FIELD

The present disclosure belongs to the technical field of internal combustion engines, in particular to a heating-type pre-combustion chamber igniter for a methanol engine under a cold start operating condition, a methanol engine and a cold start control method thereof.

### BACKGROUND

With the increasing attention to fuel shortage and air pollution control, alternative fuels have received increasing attention. Methanol is a clean fuel that can be produced and synthesized at relatively low cost from coal, natural gas and plants and has many desirable combustion and emission characteristics, such as: high octane number, good antiknock performance, high latent heat of vaporization, high density fuel-air gas mixture charge and excellent lean combustion performance. These characteristics make methanol a high-quality fuel for Otto cycle spark ignition engines. However, since a boiling point of the methanol (338K) is higher than an initial boiling point of gasoline (about 313K), and the methanol has the properties of low vapor pressure and high latent heat of vaporization, which directly leads to the problem of difficult cold start of methanol engines at low ambient temperatures.

The difficulty of methanol cold start is mainly due to the fact that at low ambient temperatures, evaporation of fuel injected into an intake manifold is severely deteriorated, with the rough estimate that only 10-20% of the fuel has evaporated during the first few cold start cycles, and the lower the ambient temperature, the richer the air-fuel gas mixture needed for starting. Traditional solutions include fuel enrichment injection, cylinder liner heating, temperature increase of inlet air and so on. Fuel enrichment injection refers to excessive fuel injection by the engine, thereby forming sufficient combustible gas mixture in the cylinder. This excessive fuel injection will lead to a large amount of liquid fuel entering the cylinder, resulting in incomplete combustion of fuel and a large amount of CO and HC emissions, which is also the main reason for excessive emissions during cold start. The object of cylinder liner heating is to heat an entire main combustion chamber and enhance the thermodynamic conditions in the main combustion chamber to achieve the purpose of stable ignition. The temperature increase of inlet air can promote the evaporation of fuel, and also enhance the thermodynamic conditions in the main combustion chamber to achieve the object of stable ignition. These two methods are infrequently used due to large energy consumption.

If the methanol engine can combust stably under the condition closer to a stoichiometric ratio during cold start, it can realize low pollutant emission on the premise of ensuring the stable start of the engine. According to William P. Attard's related research, a jet flame has three functions, namely, enhancing the thermodynamic state of the gas mixture in the main combustion chamber, the turbulence intensity and the reactivity of the gas mixture. There is a partial quenching phenomenon during flame ejected by the nozzle orifices, the quenched flame contains a large number of reaction intermediates, and these reactive groups can greatly promote the combustion of the gas mixture in the main combustion chamber. Therefore, a new auxiliary method for cold start of methanol engines is considered. By creating a high-temperature ignition environment with heating bands at the nozzles of a small pre-combustion chamber, the fuel injected into the pre-combustion chamber can be atomized and evaporated well. Then a mixing working medium in the pre-combustion chamber is ignited first to eject the jet flame. The heat brought by the jet flame strengthens the degree of fuel mixing and in-cylinder thermodynamic conditions in the main combustion chamber under cold start conditions, and improves the reactivity of working medium in the main combustion chamber.

### SUMMARY

An object of the present disclosure is to provide a pre-combustion chamber igniter, a methanol engine and a cold start control method thereof. According to the present disclosure, the pre-combustion chamber igniter is designed into a structure that the pre-combustion chamber can be heated, and a fuel injection angle is designed. The problems of difficult start-up of the methanol engine under cold start conditions and emissions caused by cold start are solved by using the three effects, namely, improving the initial thermodynamic conditions, increasing the turbulence intensity and enhancing a reactivity of a working medium, of a jet flame on an in-cylinder working medium, thereby improving the thermodynamic conditions and the turbulence intensity in a main combustion chamber, enabling the gas mixture in the main combustion chamber to be ignited and fully combusted. During the cold start, the methanol engine can be operated under conditions closer to a stoichiometric ratio, that is, it can ensure the stable start of the engine without generating excessive emission pollutants. The object of the present disclosure is realized by the following technical solutions:

A first aspect of the present disclosure relates to a pre-combustion chamber igniter, including a housing, nozzles, a fuel injector, a spark plug and heating elements. Inner walls of the nozzles and a bottom of the housing cooperate to form a pre-combustion chamber, and at least one nozzle orifice is arranged at a bottom of the pre-combustion chamber. The heating elements are attached to outer surfaces of the nozzles. The heating elements are configured to heat fuel spray sprayed to a partial inner wall of the pre-combustion chamber. An injection orifice of the fuel injector and a tail end of the spark plug 4 extend into the pre-combustion chamber with an injection direction of the fuel injector facing a direction of the spark plug, and spray of the fuel injector is injected to an inner wall of the pre-combustion chamber arranged with the heating elements.

Further, the pre-combustion chamber 6 is funnel-shaped and sequentially includes, from the bottom of the housing downward, a first region, a second region and a transition region located between the first region and the second region, and a volume ratio of the first region to the second region is 1:1. The heating elements are attached to an exterior of the first region and the transition region, and the heating elements are electrically connected to a temperature control switch.

Further, the number of the nozzle orifices is 1-10 with a diameter of 2-8 mm; preferably, 3-10 nozzle orifices are arranged.

Further, the heating element is selected from one of the following: a heating band, an embedded resistance wire and a heating rod.

Further, fan-shaped spray formed by the fuel injector is at an angle of 45° to a center axis of the spark plug.

A second aspect of the present disclosure relates to a methanol engine, including a pre-combustion chamber igniter, a cylinder head, a substrate and a movable cavity. The pre-combustion chamber igniter, an air inlet end and an air outlet end are arranged on a top of the cylinder head, and the movable cavity being arranged at an interior of the substrate and the cylinder head. The methanol engine further includes a temperature control switch. The temperature control switch is electrically connected to an alternating current power supply, arranged at one side of the pre-combustion chamber igniter, and configured to detect a temperature in a pre-combustion chamber and control the opening and closing of heating elements.

Further, a volume of the pre-combustion chamber of the pre-combustion chamber igniter is less than 5% of a volume of the movable cavity.

A third aspect of the present disclosure relates to a cold start control method for a methanol engine, including:
heating a pre-combustion chamber by controlling heating elements located on nozzles using a temperature control switch to cause a temperature in the pre-combustion chamber to reach a preset operation temperature; then moving a push rod upward to a compression top dead center with the drive of the engine, injecting fuel by a fuel injector, rapidly evaporating the same after contacting an inner wall of the heated pre-combustion chamber, mixing the same with the air to form a combustible mixture, and igniting a gas mixture in the pre-combustion chamber by a spark plug at an optimal ignition angle to form a jet flame to enter a movable cavity, a fuel injection amount of the fuel injector being determined according to a volume of the pre-combustion chamber, and the optimal ignition angle being determined by a running state of the engine; and controlling an excess air coefficient of an interior of the pre-combustion chamber between 0.8 and 1.0 to achieve ultra-lean combustion of the engine in a cold start state.

The heating elements stop operations after the methanol engine runs stably, and remaining elements of a cold start device continue to run, which can realize a turbulent jet ignition in an active pre-combustion chamber and improve an ignition ability and engine performance during lean combustion.

The cold start control method for the methanol engine is also applicable to a cold start of an engine with a fuel having a high latent heat of vaporization or a liquid ammonia fuel.

It can also be applied to the cold start problem of the engine with other fuels having high latent heat of vaporization or liquid ammonia fuels.

Compared with the prior art, the technical solution of the present disclosure brings the following advantages.
1. Compared with a traditional enrichment cold start way, the method of ignition in the injection chamber can reduce a total fuel injection quantity and fuel consumption, and the HC and CO emissions can be significantly reduced due to the full combustion in the cylinder.
2. Due to a small volume of the injection chamber (pre-combustion chamber), compared with the traditional way of heating the entire main combustion chamber, the method of heating the injection chamber (pre-combustion chamber) has faster heating speed, less energy consumption and excellent cold start ignition performance.
3. The jet flame is used in the cold start condition of the methanol engine by heating the injection chamber (pre-combustion chamber), which requires less power consumption and is more stable and reliable than a cold start mode of the temperature increase of inlet air.

### BRIEF DESCRIPTION OF THE DRAWINGS

FIG. 1 is a sectional view of a pre-combustion chamber igniter according to the present disclosure; and

FIG. 2 is a schematic structural view of a methanol engine mounted with a pre-combustion chamber igniter according to the present disclosure.

Reference numerals and denotations thereof:
100—pre-combustion chamber igniter; 1—housing; 2—nozzle; 3—fuel injector; 4—spark plug; 5—heating band; 6—pre-combustion chamber; 61—first region; 62—transition region; 63—second region; 7—sealing ring; 8—substrate; 9—air inlet end; 91—air inlet pipe; 92—air inlet valve; 10—air outlet end; 101—air outlet pipe; 102—air outlet valve; 11—push rod; 12—temperature control switch; and 13—alternating current power supply.

### DETAILED DESCRIPTION

In order to make the objects, technical solutions, beneficial effects and remarkable progress of the examples of the present disclosure clearer, the technical solutions in the examples of the present disclosure will be described clearly and completely with reference to the attached drawings provided in the examples of the present disclosure. Obviously, all the described examples are only some, rather than all examples of the present disclosure. Based on the examples in the present disclosure, all other examples obtained by those of ordinary skill in the art without creative efforts belong to the scope of protection of the present disclosure.

In the description of the present application, the terms “first”, “second” and “third” are used for descriptive purposes only and are not to be understood as indicating or implying relative importance unless explicitly stated or limited otherwise. The term “a plurality” means two or more. The terms “connected” and “fixed” are to be understood in a broad sense unless otherwise specified or indicated, for example, the “connected” may be fixedly connected, detachably connected, integrally connected, electrically connected, directly connected or indirectly connected through an intermediate medium. For those of ordinary skill in the art, the specific meanings of the above terms in the present application can be understood according to specific circumstances.

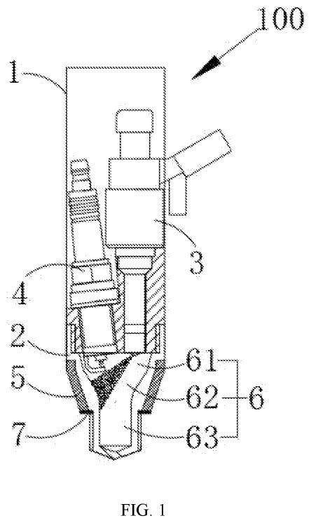

As shown in FIG. 1, a pre-combustion chamber igniter 100 includes a housing 1, nozzles 2, a fuel injector 3, a spark plug 4 and heating bands 5. The nozzles 2 are threadedly connected to a bottom of the housing 1, inner walls of the nozzles 2 and the bottom of the housing 1 cooperate to form a pre-combustion chamber 6, a bottom of the pre-combustion chamber has three nozzle orifices with a diameter of 4 mm, and the nozzle orifices are in communication with the pre-combustion chamber and a movable cavity (namely, a main combustion chamber). The nozzle orifices are uniformly distributed at a bottom of the pre-combustion chamber, so that a jet flame sprayed by the nozzles 2 uniformly covers the whole movable cavity, which successfully ignites a cold gas mixture in the movable cavity and enables the fuel to be fully combusted. Furthermore, a first threaded portion is arranged at an outer side wall of the bottom of the housing 1, and a second threaded portion engaged with the first threaded portion is arranged at an inner side wall of a top of the nozzle 2, thereby achieving a threaded connection of the nozzle 2 to the bottom of the housing 1. This design enhances the connection firmness between the housing 1 and the nozzles 2. When the nozzles 2 are damaged, it is convenient to replace the nozzles 2 quickly and improve the replacement efficiency.

The pre-combustion chamber 6 is funnel-shaped and sequentially includes, from the bottom of the housing 1 downward, a first region 61, a second region 63 and a transition region located 62 between the first region 61 and the second region 63. A cross-section of the first region 61 is inverted trapezoid-shaped and a cross-section of the second region 63 is rectangular-shaped, and an inner diameter of the transition chamber 63 decreases in a direction away from the first region 61. A volume ratio of the first region to the second region is 1:1. Compared with the traditional pre-combustion chamber, this pre-combustion chamber has a smaller volume, which can reduce energy loss and heat loss.

The heating bands 5 are attached to the outer surfaces of the nozzles 2, located at an exterior of the first region 61 and the transition region 62, and electrically connected to a temperature control switch 12. The fuel injector 3 is a single-orifice fuel injector arranged at an interior of the housing 1, and an injection orifice of the fuel injector 3 extends into the pre-combustion chamber 6. Fan-shaped spray formed by the fuel injector is at an angle of 45° to a center axis of the spark plug 4, so that an injection direction faces a direction of the spark plug 4, and the spray mainly injects towards the first region 61 and the transition region 62 with larger volumes (as shown in FIG. 1); the spark plug 4 is partially arranged at the interior of the housing 1, and a head of the spark plug 4 is located in an injection chamber 6 and corresponds to the injection orifice of the fuel injector 3.

Due to this structure design, the spray of the fuel injector 3 is mainly formed in the first region 61 and the transition region 62 of the pre-combustion chamber 6. With the cooperation of the heating bands 5 located on an outer wall of the first region 61 and the transition region 62, the fuel gas mixture inside the pre-combustion chamber 6 can achieve good atomization and evaporation. The spark plug 4 ignites the gas mixture inside the pre-combustion chamber 6, so that the sprayed jet flame ignites the cold gas mixture in the movable cavity (i. e. the main combustion chamber) by the nozzle orifices, thereby achieving reliable cold start of the methanol engine. According to the actual situation, the heating bands 5 can use a structure similar to an embedded resistance wire and a heating rod.

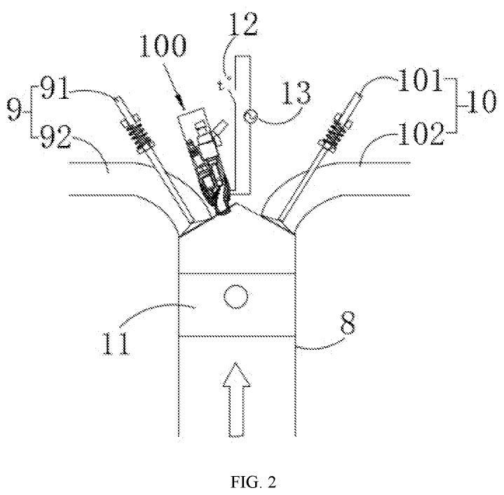

As shown in FIG. 2, a methanol engine includes a pre-combustion chamber igniter 100, a cylinder head, a substrate 8, an air inlet end 9, an air outlet end 10 and a push rod 11 movably mounted in the substrate 8. The pre-combustion chamber igniter 100, the air inlet end 9 and the air outlet end 10 are arranged at a top of the cylinder head, the air inlet end 9 and the air outlet end 10 are located at two sides of the pre-combustion chamber igniter 100, a movable cavity is arranged at an interior of the substrate 8 and the cylinder head, the push rod 11 abuts against an inner wall of the movable cavity, and a volume of the pre-combustion chamber 6 of the pre-combustion chamber igniter 100 is less than 5% of a volume of the movable cavity, thereby ensuring that existing ignition engines for vehicles can be used without major modifications. The air inlet end 9 includes an air inlet pipe 91 and an air inlet valve 92 for introducing gas, and the air outlet end 10 includes an air outlet pipe 101 and an air outlet valve 102 for discharging gas. The methanol engine further includes a temperature control switch 12. The temperature control switch 12 is electrically connected to an alternating current power supply 13, arranged at one side of the pre-combustion chamber igniter 100, and configured to detect a temperature in a pre-combustion chamber 6 and control the opening and closing of the heating bands.

When the pre-combustion chamber igniter 100 is mounted, firstly, the fuel injector 3 and the spark plug 4 are mounted on the housing 1, and then the nozzles 2 are threadedly mounted under the housing 1. The heating bands 5 are attached to outer surfaces of the nozzles 2, and are connected to the temperature control switch 12 and the alternating current power supply 13 by a high-temperature-resistant wire, with the injection direction facing the direction of the spark plug 4. The pre-combustion chamber igniter 100 is screwed on the cylinder head through threads on the outer walls of the nozzles 2, which are sideways and located at the side of the air inlet valve 92. The gaps between the nozzles 2 and the cylinder head are sealed with a metal sealing ring 7. In the sealing process, the sealing is realized by slight deformation of the metal sealing ring, thereby improving the sealing performance between the nozzles 2 and the cylinder head.

The ignition control method for the methanol engine under the cold start condition is as follows.

Firstly, a pre-combustion chamber 6 is heated by controlling heating bands 5 located on nozzles 2 using a temperature control switch 12 to cause a temperature in the pre-combustion chamber 6 to reach a preset operation temperature. Then, with the drive of the engine, a push rod 11 is moved upward to a compression top dead center, namely, at the first 180° CA (specifically calibrated according to parameters of different engines), the fuel injector 3 injects a small amount of fuel (the amount of the fuel injected needs to be determined according to the volume of the pre-combustion chamber 6), the fuel is rapidly evaporated upon contacting an inner wall of a high temperature pre-combustion chamber 6, and is mixed with the air to form a combustible mixture; a gas mixture in the pre-combustion chamber 6 is ignited by a spark plug 4 at an optimal ignition angle to form a jet flame to enter a movable cavity (a main combustion chamber) to ensure the stable start of the engine. The optimal ignition angle is the compression top dead center where the piston reaches and is determined by a running state of the engine. An excess air coefficient of an interior of the pre-combustion chamber 6 is controlled between 0.8 and 1.0 to achieve ultra-lean combustion of the engine in a cold start state, thereby improving the thermal efficiency.

After the spark plug 4 successfully ignites the gas mixture in the pre-combustion chamber 6, the interior of the pre-combustion chamber 6 will be ignited firstly, and then multiple jet flames are ejected by the nozzles 2 at an accelerated speed, so that the cold gas mixture in the movable cavity (the main combustion chamber) is successfully ignited and fully combusted. The heating bands 5 stop operating after the methanol engine runs stably.

In the normal running of the engine, the heating bands 5 are not operated and the remaining elements continue to operate.

In conclusion, the methanol engine cold start device in the example of the present disclosure improves the ignition performance in the main combustion chamber by introducing a jet flame into the main combustion chamber by heating the pre-combustion chamber 6. Since the main energy of the jet flame comes from fuel combustion, the requirements for battery are not high, the system reliability is higher, and the stability of cold start is better. It is to be noted that the fuels in the examples of the present disclosure include but are not limited to methanol, and can also be extended to the cold start of fuels such as alcohols, ethers and gasoline, and the related art is also instructive for marine and other internal combustion engines to a certain extent.

In addition, it is to be understood that while the specification has been described in terms of embodiments, not each embodiment only contains an independent technical solution, and that this description is for clarity only. Those skilled in the art are to take the specification as a whole, and the technical solutions in the examples can also be combined appropriately to form other embodiments that can be understood by those skilled in the art.

1. A pre-combustion chamber igniter, comprising: a housing (1), nozzles (2), a fuel injector (3), a spark plug (4) and heating elements (5), inner walls of the nozzles (2) and a bottom of the housing (1) cooperating to form a pre-combustion chamber (6), and at least one nozzle orifice being arranged at a bottom of the pre-combustion chamber (6); the heating elements (5) being attached to outer surfaces of the nozzles (2); the heating elements (5) being configured to heat fuel spray sprayed to a partial inner wall of the pre-combustion chamber (6); and an injection orifice of the fuel injector (3) and a tail end of the spark plug (4) extending into the pre-combustion chamber (6) with an injection direction of the fuel injector (3) facing a direction of the spark plug (4), and spray of the fuel injector being injected to an inner wall of the pre-combustion chamber arranged with the heating elements.

2. The pre-combustion chamber igniter according to claim 1, wherein the pre-combustion chamber (6) is funnel-shaped and sequentially comprises, from the bottom of the housing (1) downward, a first region (61), a second region (63) and a transition region (62) being located between the first region (61) and the second region (63), a volume ratio of the first region (61) to the second region (63) being 1:1; and the heating elements are attached to an exterior of the first region (61) and the transition region (62), and the heating elements are electrically connected to a temperature control switch (12).

3. The pre-combustion chamber igniter according to claim 1, wherein the number of the nozzle orifices is 1-10 with a diameter of 2-8 mm.

4. The pre-combustion chamber igniter according to claim 1, wherein the heating element is selected from one of the following: a heating band, an embedded resistance wire and a heating rod.

5. The pre-combustion chamber igniter according to claim 1, wherein fan-shaped spray formed by the fuel injector (3) is at an angle of 45° to a center axis of the spark plug (4).

6. A methanol engine, comprising a pre-combustion chamber igniter (100) according to claim 1, a cylinder head, a substrate (8), and a movable cavity, the pre-combustion chamber igniter (100), an air inlet end (9) and an air outlet end (10) being arranged on a top of the cylinder head, and the movable cavity being arranged at an interior of the substrate (8) and the cylinder head; and the methanol engine further comprising a temperature control switch (12), the temperature control switch (12) being electrically connected to an alternating current power supply (13), arranged at one side of the pre-combustion chamber igniter (100), and configured to detect a temperature in a pre-combustion chamber (6) and control the opening and closing of heating elements (5).

7. The methanol engine according to claim 6, wherein a volume of the pre-combustion chamber (6) of the pre-combustion chamber igniter (100) is less than 5% of a volume of the movable cavity.

8. A cold start control method for a methanol engine according to claim 6, comprising:
heating a pre-combustion chamber (6) by controlling heating elements (5) located on nozzles (2) using a temperature control switch (12) to cause a temperature in the pre-combustion chamber (6) to reach a preset operation temperature; then moving a push rod (11) upward to a compression top dead center with the drive of the engine, injecting fuel by a fuel injector (3), rapidly evaporating the same after contacting an inner wall of the heated pre-combustion chamber (6), mixing the same with the air to form a combustible mixture, and igniting a gas mixture in the pre-combustion chamber (6) by a spark plug (4) at an optimal ignition angle to form a jet flame to enter a movable cavity, a fuel injection amount of the fuel injector being determined according to a volume of the pre-combustion chamber (6), and the optimal ignition angle being determined by a running state of the engine; and controlling an excess air coefficient of an interior of the pre-combustion chamber (6) between 0.8 and 1.0 to achieve ultra-lean combustion of the engine in a cold start state; and
the heating elements (5) stopping operations after the methanol engine runs stably, and remaining elements of a cold start device continuing to run.

9. The cold start control method for the methanol engine according to claim 8, wherein the method is also applicable to a cold start of a liquid ammonia fuel engine.
